(19) United States
(12) Patent Application Publication
(10) Pub. No.: US 2024/0320232 A1
(43) Pub. Date: Sep. 26, 2024

(54) OBSERVABILITY DATA NORMALIZATION FOR SEQUENCED EVENTS

(71) Applicant: Cisco Technology, Inc., San Jose, CA (US)

(72) Inventors: Thomas Vegas, Gland (CH); Anirban Karmakar, Ecublens (CH)

(21) Appl. No.: 18/124,108

(22) Filed: Mar. 21, 2023

(51) Int. Cl. G06F 16/2458; G06F 16/22; G06F 16/28

(52) U.S. Cl. CPC G06F 16/2477; G06F 16/2255; G06F 16/287

(57) ABSTRACT

According to one or more embodiments of the disclosure, an example process herein may comprise: obtaining observability data for sequenced events in a computing network; normalizing each event of the sequenced events into a hashed event value; associating observability data corresponding to each event to a particular time range indicator of a plurality of time range indicators representative of respective event completion time ranges; and storing the observability data for the sequenced events as corresponding hashed event values and corresponding associated time range indicators.

### TECHNICAL FIELD

The present disclosure relates generally to computer systems, and, more particularly, to observability data normalization for sequenced events.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

In particular, increased proliferation and adoption of Internet of things (IoT) devices has resulted in rapid expansion of the amount of devices accessing components and/or services across a given network. As a result, there has been a corresponding rapid expansion in the amount of observability data available for consumption across these networks. For example, a multitude of devices may simultaneously produce large volumes of telemetry data on a computing network that can quickly overwhelm the ability of contemporary data storage and/or observability intelligence platforms to accommodate, communicate, and/or analyze telemetry data.

As a result, it has become nearly impossible to extract and correlate meaningful event sequences in this mass of observability data. Therefore, common failures among devices and/or services across a computing network may go unidentified. Consequently, network and/or service degrading conditions may be allowed to persist unchecked. For example, a realistic scenario may include observability data being produced by client onboarding across thousands of access points (APs). Using contemporary approaches to storing, communicating, processing, etc. AP/client events, it would be nearly impossible to identify a common failure pattern among the onboarding wireless clients within the vast expanse of events produced across the thousands of APs.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example of an architecture for observability data normalization for sequenced events;

FIG. 5 illustrates an example of a query operation for normalized observability data of sequenced events; and

FIG. 6 illustrates an example simplified procedure for observability data normalization for sequenced events in accordance with one or more embodiments described herein.

### DESCRIPTION OF EXAMPLE EMBODIMENTS

### Overview

According to one or more embodiments of the disclosure, an example process herein may comprise: obtaining observability data for sequenced events in a computing network; normalizing each event of the sequenced events into a hashed event value; associating observability data corresponding to each event to a particular time range indicator of a plurality of time range indicators representative of respective event completion time ranges; and storing the observability data for the sequenced events as corresponding hashed event values and corresponding associated time range indicators.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

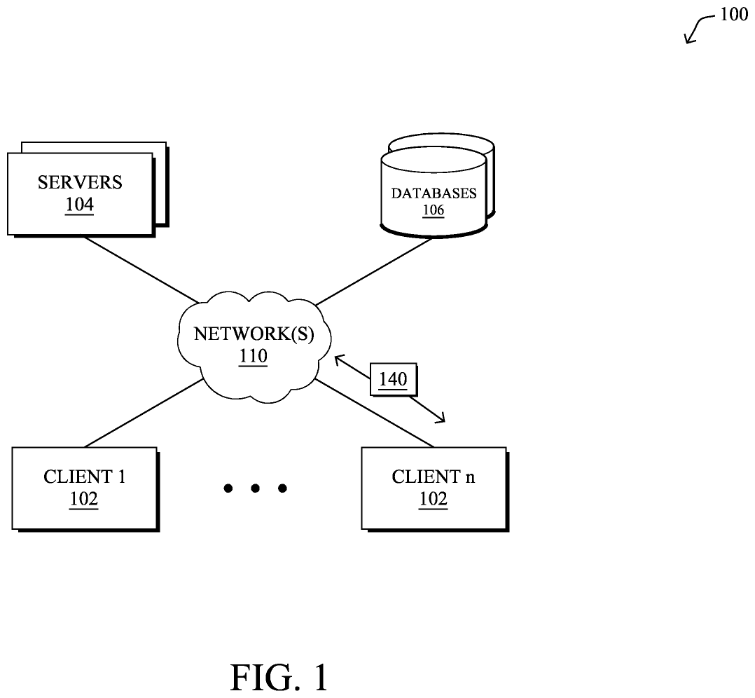

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

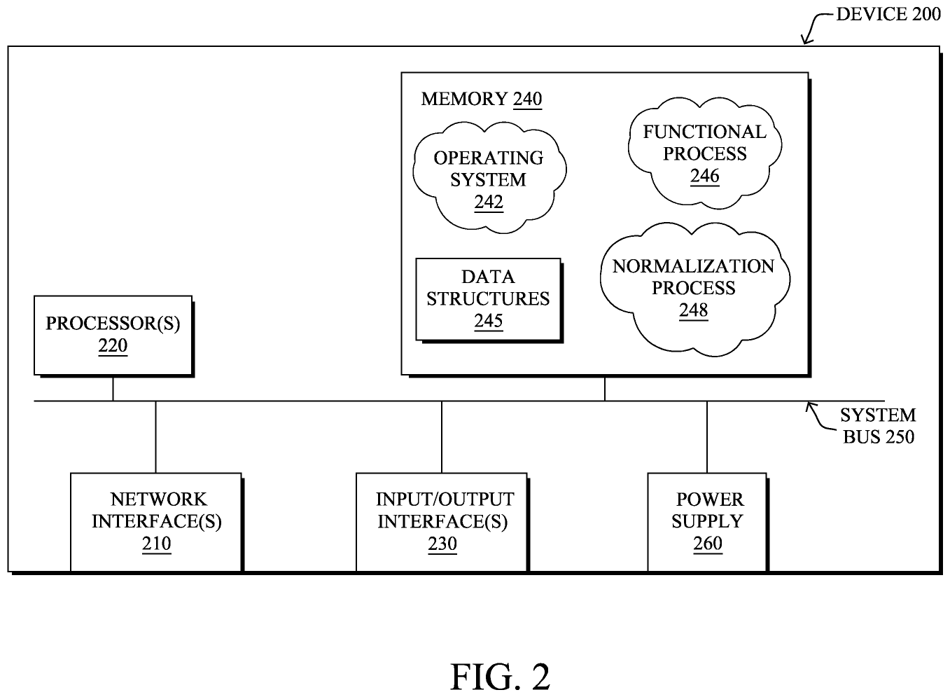

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative normalization process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### —Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

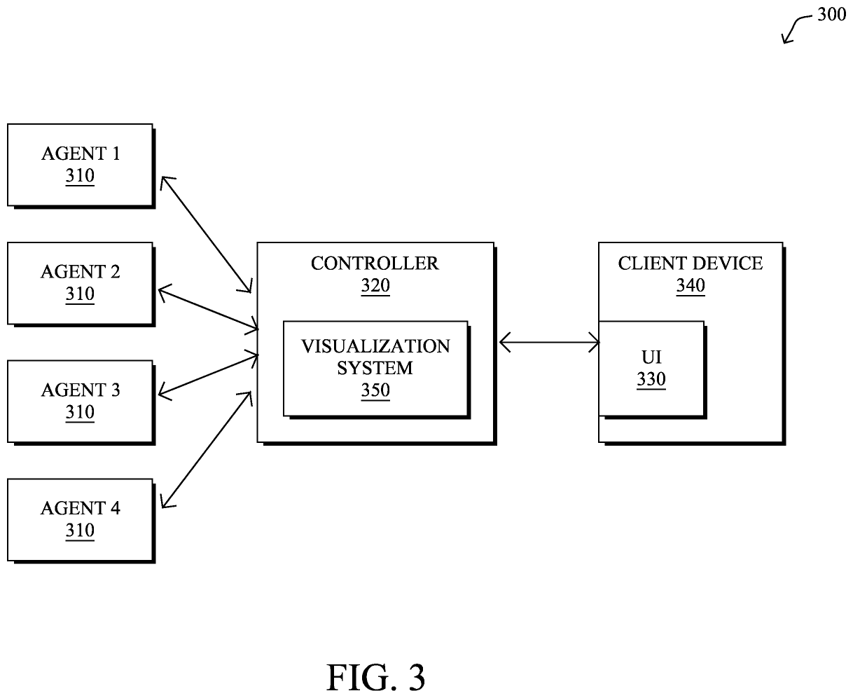

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### —Observability Data Normalization for Sequenced Events—

As noted above, identifying common failure patterns within an expansive quantity of events occurring in a computing network is exceptionally difficult if not impossible with the current ways of storing, communicating, analyzing observability data. This deficit is only made worse by the heterogeneity of services and/or IoT and other devices in the network which may yield equally heterogenous telemetry data. For example, without a standardized format for telemetry data, even if that data that is collected, stored, and/or communicated, it is very difficult to compare across formats. However, standardizing observability data formats across devices, services, manufacturers, network types, etc. is an approach that would require dedication to cooperation and collaboration on an industry-wide scale which has traditionally proved challenging.

In contrast, the techniques herein, introduce mechanisms that enable generalized and quick observability data correlation capabilities. These techniques facilitate efficient searching for common patterns in an event stream. The techniques accomplish this by introducing an efficient mechanism for data storage, communication, and/or organization that maintains high searchability and relevant data inclusion in compact formulation. For instance, these techniques reshape how data is stored, communicated, organized, and/or searched by introducing a method to transform observability data into a more efficient format through normalization of timestamps and event identifiers using a combination of hashing and logarithmic conversion.

Specifically, according to one or more embodiments described herein, an example process herein may comprise: obtaining observability data for sequenced events in a computing network; normalizing each event of the sequenced events into a hashed event value; associating observability data corresponding to each event to a particular time range indicator of a plurality of time range indicators representative of respective event completion time ranges; and storing the observability data for the sequenced events as corresponding hashed event values and corresponding associated time range indicators.

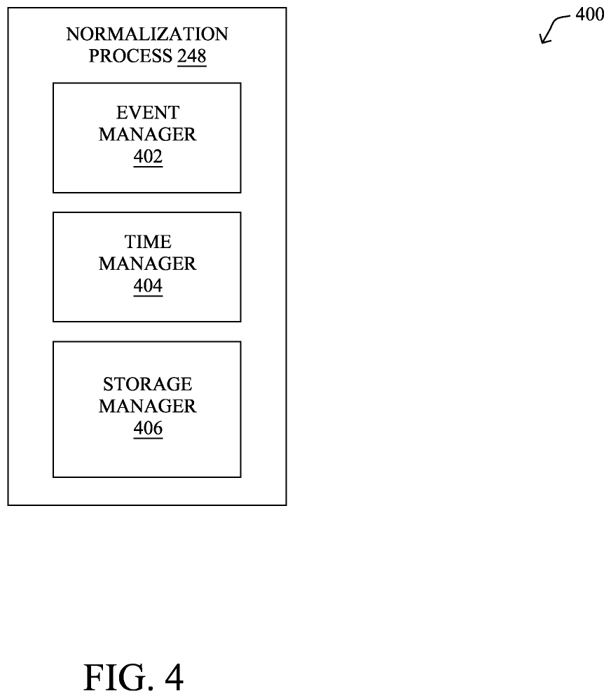

Operationally, FIG. 4 illustrates an example of a simplified architecture 400 for observability data normalization for sequenced events, according to various embodiments. At the core of architecture 400 is normalization process 248. Normalization process 248 may be executed by a device that provides a portion of an observability intelligence platform and/or a visualization system for visualizing observability data for a computing network, or another device in communication therewith. In general, normalization process 248 may be executed to provide normalized observability data and, therefore, may be executed on any device associated with the collection, storage, communication, analysis, etc. of observability data for a computing network.

As shown, normalization process 248 may include an event manager 402, a time manager 404, and/or a storage manager 406. As would be appreciated, the functionalities of these components may be combined or omitted, as desired. In addition, these components may be implemented on a singular device or in a distributed manner, in which case the combination of executing device can be viewed as their own singular device for purposes of executing normalization process 248.

Normalization process 248 may obtain observability data from a computer network for a given period of time. For example, normalization process 248 may obtain observability data such as telemetry data, metrics, events, logs, traces (e.g., “MELT” data), timestamps and/or other outputs of observability analytics. This observability data may be collected via an observability intelligence platform and/or other mechanisms of observability data collection and/or aggregation.

This observability data may be collected and/or operated on in its native format. This may mean that the observability data is not formatted, reformatted, formalized, standardized, etc. in a particular way and/or does not necessarily adhere to a formatting standard. Normalization process 248 may perform operations (e.g., computations, transformations, etc.) to the collected observability data.

The observability data obtained by normalization process 248 may include observability data for sequenced events in a computing network. An event may include data defining the attributes of a discrete action happening at a moment in time. In some instances, the attributes may include a timestamp associated with the event, a type of the event, identifiers associated with the event or a transaction, various values associated with the event, etc. In various embodiments, an event may be represented as a string, id/type, enumerated type, etc. The event may have parameters and can also include tags. In some instances, the event may comprise a composed textual line, such as a file filled with logs.

Sequenced events may be a stream of events occurring in a recognizable sequence or pattern. In an example, sequenced events may include a sequence of events associated with a process such as onboarding wireless clients to a wireless platform. This process may, for example, include a pattern of events including an association event, an authentication event, a pairwise master key (PMK) association start, a PMK association done, a dynamic host configuration protocol (DHCP) association start, a DCHP association done, etc. The observability data for each of these events may include an identifier of the type of event and/or a timestamp associated with the event (e.g., the start time, the finish time, the time duration, etc.).

When executed, event manager 402 may manage the transformation of each event of the sequenced events into a corresponding normalized value via a common transformation method. For example, event manager 402 may translate each natively formatted event in a sequence into a corresponding hashed value. The event manager 402 may then reduce each hashed value into a limited set of values. The limited set of values may correspond to:

$$EV = Hash ( Event ) \% set\_size .$$

The set_size may be a configurable value. In some instances, set_size may be equal to 65535. The Event Value (EV) may be 2 bytes in size. This transformation may produce very infrequent collisions, with one event being represented by the same value in the set. Further, any collisions will likely not be located closely in the data set.

Ultimately, the EV may be used in correlation functions applied to the sequenced events. In particular, event manger 402 may produce a sequence of hashed values among which it is unlikely that many collisions appear in a given sequence. Therefore, the memory comparison may remain valid without any false positives.

When executed, time manager 404 may manage the transformation of each timestamp of each event of the sequenced events into a corresponding normalized value via a common transformation method. Traditionally, the variability of time intervals and/or timestamp formatting for event occurrence has made correlation very difficult. Often, a timestamp is completely removed and only the event sequence is compared regardless of whether the events occur within ten seconds of one another or ten hours of one another.

Time manager 404 may transform the timestamps by normalizing them to normalized time intervals elapsed since a prior event. In various embodiments, time manager 404 may determine, for each event, an amount of time that has elapsed since a prior event (e.g., an event completion time) based on the native timestamp of the event and/or the prior event in a sequence of events.

Time manager 404 may associate each event to a group (e.g., represented by a one-byte value) that encompasses a range of event completion time values. The time ranges include in a particular group may be manually configured, may be determined based on dividing the observability data's completion time values into a number of ranges, may be determined based on a logarithmic scale timestamp normalization method, etc. The groups may correspond to logical bins that may be conceptualized as representing different classifications of a length of a completion time relative to each other and/or an expected completion time for a known process. For example, the groups may represent a relatively fast event completion time, a relatively average or expected event completion time, a relatively slow event completion time, and/or various other levels of granularity in comparison to expected values or other values, respectively. Regardless of how the groups are defined or formatted and/or which group an event completion time is assigned, the underlying actual absolute timestamp value for the event (e.g., the one which was used to calculate the completion time value for grouping) may be stored and/or kept and differentiated from to avoid any long-term time drift.

In some examples, time manager 404 may utilize a logarithmic scale timestamp normalizing method that may correspond to the following transformation:
delta_time=log₁₀ (delta time between two events).
   In various embodiments, the timestamp of two events may be differentiated and their value in milliseconds fed into that transformation. For instance, event completion time values between one millisecond and nine milliseconds may be transformed into the normalized timestamp value of zero, event completion time values between ten milliseconds and nine milliseconds may be transformed into the normalized timestamp value of one, event completion time values between one second and nine point nine-nine seconds may be transformed into the normalized timestamp value of three, event completion time values between ten seconds and ninety-nine seconds may be transformed into the normalized timestamp value of four, etc.

When executed, storage manager 406 may manage completion, storage, communication, and/or utilization of the normalized event representations. For example, storage manager 406 may perform a normalized event representation and correlation technique. For instance, the storage manager 406 may cause the storage, communication, and/or utilization of the normalized event representations. The normalized event representations may be represented in the following format:

$$delta\_time = 1 byte ( allows {10}^{256} ms representation )$$

$$EV : 2 bytes .$$

This format may be configured for use in event sequence correlation. In addition, there may be a header describing properties such as the owner of an event stream (e.g., a wireless client, etc.).

The event stream may be generated on-the-fly and/or be referring to actual non-normalized logs/events. However, it can also be sent directly from a source device. Again, there may be no need for a specific and/or standardized event format and/or formalism. Instead, normalization process may transform the non-standardized/non-formalized event data into a normalized set of values.

To provide an example, a particular event sequence constructed from non-standardized/non-formalized event data may be transformed by execution of event manager 402, time manager 404, storage manager 406 to a representative array such as:
{0,432, 1,432, 3,54}.
   This array may correspond to and/or represent an initial occurrence of an event mapped to the normalized value of 432, the recurrence of the event mapped to normalized value 432 within ten milliseconds of the initial occurrence, and then the occurrence of an event mapped to normalized value 54 within one to ten seconds later.

Storage manager 406 may cause such a representation to be stored, communicated, and/or utilized for correlation and/or identification of similar patterns in event streams at scale. Storage manager 406 may facilitate the identification of common event and/or event completion time patterns in event streams utilizing, for example, a byte-string searching algorithm (e.g., memcmp( ), etc.), which may be used without any further conversion. In addition, storage manager 406 may store differentiated timestamps to facilitate string searching in a buffer containing an arbitrary number of events. In some examples, storage manager 406 may store the normalized representations of the observability data for the sequenced events indexed by their corresponding hashed event values and their corresponding associated time range indicators.

Storage manager 406 may perform compact data transfers of the normalized event values and/or event time completion values. For instance, by communicating the event data in the above-described normalized format, compact data transfers and user interface (UI) visualization of observability data trends and relationships at scale may be achieved. For example, event data associated with a huge number of devices, entities, clients, etc. can be compactly stored, communicated and/or searched utilizing the normalized values.

In some examples, storage manager 406 may cause a visual representation of the devices, entities, clients, etc. associated with a particular queried event to be generated. The visual representation of each device, entity, client, etc. may further graphically represent a respective event completion time range corresponding to that client. For instance, each device, entity, client, etc. may be graphically represented by a colored square (e.g., red, green, etc.) corresponding to a grouping to which the event and/or its corresponding event completion time is assigned. Large scale graphical representations may be achieved in this manner.

Storage manager 406 may provide binary correlation (e.g., yes or no, etc.) for similar event sequence correlation operations. For example, event manager 402 may take an event as an input and generate a constant hash value for that event. The event function may include an input of event, as enumeration, string, or combination, based on parameters of interest and an output of the above-described normalized event identifying value (ID). This ID may be combined with the above-described normalized event completion time value (TS) yielded from the timestamp normalization technique executed by time manager 404. The ID combined with the TS may be flattened by storage manager 406 into a list of tuples such as, for example: [{TS1, ID} {TS2, ID2} . . . ]→[TS1, ID1, TS2, ID2 . . . ]. From here, a memory comparison may be performed to identify matching or repeating patterns in the data. For example, a search for a particular type of event may be based on matching the hash value corresponding to an event specified in a query to the hash values in the normalized data stream. Further, a search for a particular type of event occurring a particular duration after a prior one may be searched for on the basis of matching the hash value corresponding to an event specified in a query and the normalized event completion time value specified in the query to matching instances in the normalized data stream.

The normalization technique of normalization process 28 may be applied on data on every relevant stream or on demand (e.g., the system keeping tack as an offset in the original event stream, etc.). In addition, the technique may be applied for a given query on an agent or from a UI directly to be sent to backend for faster searching. A script (e.g., javascript) on a user agent may also be used to preprocess a user query. In various embodiments, a string of normalized event data to be searched for may be transferred as for example:
JSON: {“query”: [0, 432, 10, 1039, 12, 9843]}.
   There may be no need to convert back to the original data. Instead, the response of a given REST API may either be matched or not matched, containing the list of position in the original event stream.

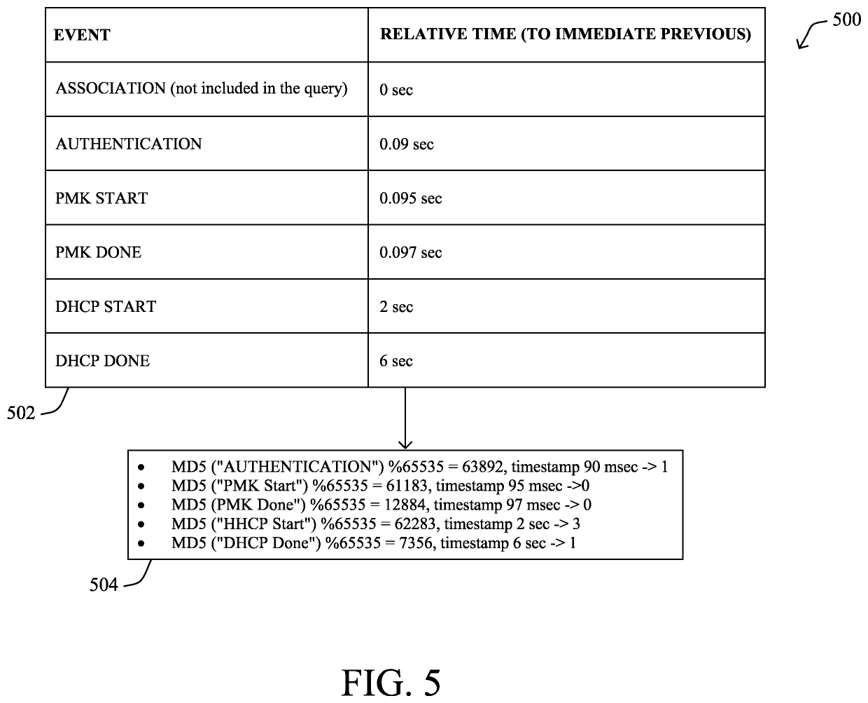

FIG. 5 illustrates an example of a query operation 500 for normalized observability data of sequenced events, according to various embodiments. The query operation 500 may involve creation and/or submission of a query 502. For example, a user may be interested in finding out all of the wireless clients on a wireless platform that experienced a slow onboarding sequence of events. Query 502 may be used as a portion of an analysis of potential existing IP learn latency issues occurring in a computing network.

A user may utilize a UI to build query 502 specifically configured to reveal a targeted slow onboarding occurrence. For example, the user may specify a query 502 by describing a search event sequence with attributes of a slow onboarding occurrence that could then match a specific pattern observed in the sequence of events. For example, the query 502 may specify a search for a pattern matching an authentication event completion at 0.09 seconds relative time to prior event, a pairwise master key (PMK) association start at 0.095 seconds relative time to prior event, a PMK association done at 0.097 seconds relative time to prior event, a dynamic host configuration protocol (DHCP) association start at 2 seconds relative time to prior event, and/or a DCHP association done at 6 seconds relative time to prior event.

The UI may process this query 502 request. Specifically, the query 502 may be processed as following md5/modulo and log mapping of timestamp to the mapped request 504. Mapped request 504 may be formatted in a manner that corresponds to the normalized event value and event completion time value. That is, the event type specified in the query 502 may be mapped to its corresponding hash value and set size value and the event completion times specified in the query 502 may be mapped to its corresponding event completion time value representing the group of event completion times that it fits within. Of note, even if the user had specified a DHCP one to 9 seconds after the DHCP start, the pre-processed mapped request 504 would have been the same. In this manner, approximate matching may be enabled.

The request vector built in memory may be of the size (1+2)*5=15 bytes:

$$Req = \{ 1 , 63892 , 0 , 61183 , 0 , 12884 , 3 , 62283 , 1 , 7356 \}$$

The backends may be performing the same processes on the stream per wireless client and/or on demand per wireless client. A byte comparison function, such as memcmp( ), may then perform the search in the stored normalized event sequence data. The search may be performed with an approximate timestamp comparison (e.g., more or less X seconds later). With the previously described normalization there may be no need for complex time range checking (e.g., if between x and y timespan), custom event mapping (e.g., everything normalized or standardized), etc.

The response generated by query operation 500 may include a list of matching data. In some examples, this response may include a list of MAC addresses for clients that exhibit the pattern. In additional examples, when many clients match the request, the clients may be presented with corresponding graphical indicators (e.g., colored squares, etc.) representative of their match state (e.g., green squares are do not match the queried pattern, red squares do match the queried pattern, etc.) Such listing may be selectable and/or expandable in order that a user may drill down to identify more specifics about the match and/or access the underlying observability data records themselves.

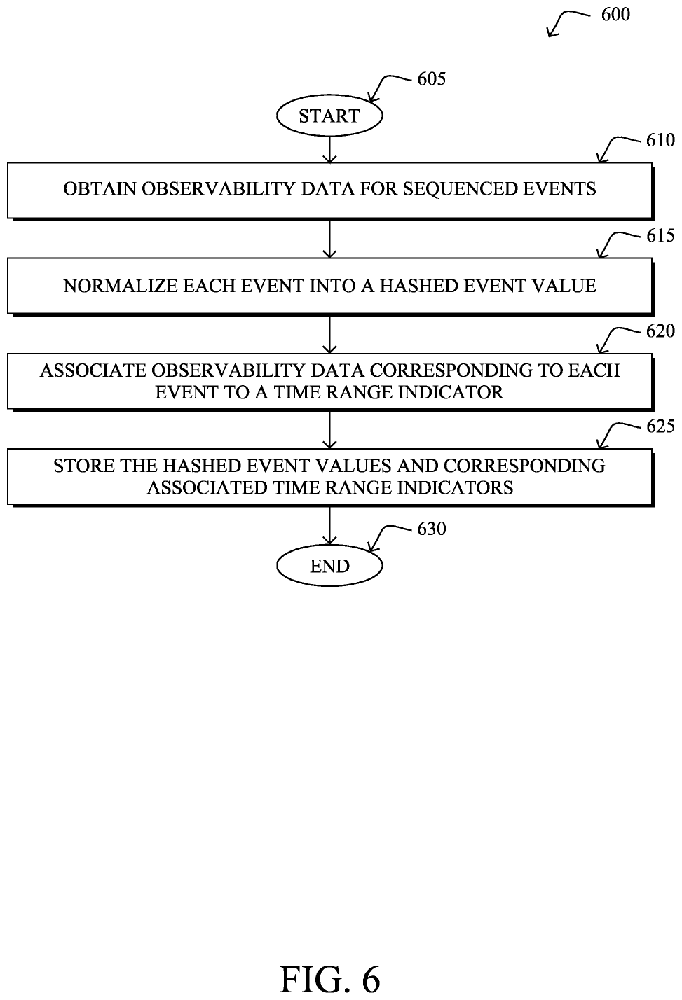

In closing, FIG. 6 illustrates an example simplified procedure for observability data normalization for sequenced events, in accordance with one or more embodiments described herein. For example, a non-generic, specifically configured device (e.g., device 200) may perform procedure 600 by executing stored instructions (e.g., normalization process 248). The device may be an observability agent sending the observability data for the sequenced events stored as corresponding hashed event values and corresponding associated time range indicators to a central server. In various embodiments, the device may be a central server, receiving the observability data in a raw format from a plurality of agents.

The procedure 600 may start at step 605, and continues to step 610, where, as described in greater detail above, a device may obtain observability data for sequenced events in a computing network. The observability data for the sequenced events may be obtained in a non-normalized and/or non-standardized format. Each event of the sequenced events may be obtained in a representative format selected from a group consisting of a string; an identifier; a type; an enumeration; a composed textual line; a file; and a log entry.

At step 615, as detailed above, the device may normalize each event of the sequenced events into a hashed event value. The hashed event value may be a two-byte representation of a hash of an event and a corresponding set size value.

At step 620, as detailed above, the device may associate observability data corresponding to each event to a particular time range indicator of a plurality of time range indicators representative of respective event completion time ranges. The event completion time ranges may be based on a logarithmic scale. In some examples, the respective event completion time ranges may be manually configured. In additional examples, the respective event completion time ranges are determined based on dividing the observability data into a number of ranges. The plurality of time range indicators representative of respective event completion time ranges may be one-byte representations.

At step 625, at detailed above, the device may store the observability data for the sequenced events as corresponding hashed event values and corresponding associated time range indicators. The observability data for the sequenced events may be represented by an array of hashed event values and time range indicators. The observability data for the sequenced events may be stored as corresponding hashed event values and corresponding associated time range indicators are stored as a three-byte pair.

In various embodiments, the observability data for the sequenced events may be stored by indexing by their corresponding hashed event values and their corresponding associated time range indicators. In some examples, storing the observability data for the sequenced events may include appending an owner of an event stream to the observability data being stored.

The simplified procedure 600 may then end in step 655, notably with the ability to continue obtaining and/or normalizing observability data for sequenced events. Other steps may also be included generally within procedure 600. For example, such steps (or, more generally, such additions to steps already specifically illustrated above), may include: generating a response to a query regarding the observability data by specifying a list of clients associated with one or more particular queried events and/or one or more particular queried event completion time ranges; generating a response to a query regarding the observability data by creating a visual representation of clients associated with a particular queried event, wherein the visual representation of each client further represents a respective event completion time range corresponding to that client; and so on.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for observability data normalization for sequenced events. In particular, the techniques herein introduce mechanisms that enable generalized and quick observability data correlation capabilities. These techniques facilitate efficient searching for common patterns in an event stream. The techniques accomplish this by introducing an efficient mechanism for data storage, communication, and/or organization that maintains high searchability and relevant data inclusion in compact formulation. For instance, these techniques reshape how data is stored, communicated, organized, and/or searched by introducing a method to transform observability data into a more efficient format through normalization of timestamps and event identifiers using a combination of hashing and logarithmic conversion.

Illustratively, the techniques described herein may be performed by hardware, software, and/or firmware, such as in accordance with the illustrative normalization process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: obtaining, by a device, observability data for sequenced events in a computing network; normalizing, by the device, each event of the sequenced events into a hashed event value; associating, by the device, observability data corresponding to each event to a particular time range indicator of a plurality of time range indicators representative of respective event completion time ranges; and storing, by the device, the observability data for the sequenced events as corresponding hashed event values and corresponding associated time range indicators.

In one embodiment, the observability data for the sequenced events is represented by an array of hashed event values and time range indicators. In one embodiment, the observability data for the sequenced events stored as corresponding hashed event values and corresponding associated time range indicators are stored as a three-byte pair. In one embodiment, event completion time ranges are based on a logarithmic scale. In one embodiment, the method further comprises generating a response to a query regarding the observability data by specifying a list of clients associated with one or more particular queried events and/or one or more particular queried event completion time ranges.

In one embodiment, the method further comprises generating a response to a query regarding the observability data by creating a visual representation of clients associated with a particular queried event, wherein the visual representation of each client further represents a respective event completion time range corresponding to that client. In one embodiment, the hashed event value includes a two-byte representation of a hash of an event and a corresponding set size value. In one embodiment, the plurality of time range indicators representative of respective event completion time ranges comprises one-byte representations. In one embodiment, the observability data for the sequenced events is obtained in a non-normalized format. In one embodiment, the method further comprises storing the observability data for the sequenced events indexed by their corresponding hashed event values and their corresponding associated time range indicators.

In one embodiment, each event of the sequenced events is in a representative format selected from a group consisting of: a string; an identifier; a type; an enumeration; a composed textual line; a file; and a log entry. In one embodiment, the respective event completion time ranges are manually configured. In one embodiment, the respective event completion time ranges are determined based on dividing the observability data into a number of ranges. In one embodiment, storing the observability data for the sequenced events further comprises: appending an owner of an event stream to the observability data being stored.

In one embodiment, the device is an observability agent sending the observability data for the sequenced events stored as corresponding hashed event values and corresponding associated time range indicators to a central server. In one embodiment, the device is a central server, receiving the observability data in a raw format from a plurality of agents.

According to the embodiments herein, an illustrative tangible, non-transitory, computer-readable medium herein may have computer-executable instructions stored thereon that, when executed by a processor on a computer, may cause the computer to perform a method comprising: obtaining observability data for sequenced events in a computing network; normalizing each event of the sequenced events into a hashed event value; associating observability data corresponding to each event to a particular time range indicator of a plurality of time range indicators representative of respective event completion time ranges; and storing the observability data for the sequenced events as corresponding hashed event values and corresponding associated time range indicators.

In one embodiment, the process further comprising: generating a response to a query regarding the observability data including one or more of: a list of clients associated with one or more particular queried events and/or one or more particular queried event completion time ranges; and a visual representation of clients associated with a particular queried event, wherein the visual representation of each client further represents a respective event completion time range corresponding to that client. In one embodiment, the process further comprising: storing the observability data for the sequenced events indexed by their corresponding hashed event values and their corresponding associated time range indicators.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: obtain observability data for sequenced events in a computing network; normalize each event of the sequenced events into a hashed event value; associate observability data corresponding to each event to a particular time range indicator of a plurality of time range indicators representative of respective event completion time ranges; and store the observability data for the sequenced events as corresponding hashed event values and corresponding associated time range indicators.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
obtaining, by a device, observability data for sequenced events in a computing network;
normalizing, by the device, each event of the sequenced events into a hashed event value;
associating, by the device, observability data corresponding to each event to a particular time range indicator of a plurality of time range indicators representative of respective event completion time ranges; and
storing, by the device, the observability data for the sequenced events as corresponding hashed event values and corresponding associated time range indicators.

2. The method as in claim 1, wherein the observability data for the sequenced events is represented by an array of hashed event values and time range indicators.

3. The method as in claim 1, wherein the observability data for the sequenced events stored as corresponding hashed event values and corresponding associated time range indicators are stored as a three-byte pair.

4. The method as in claim 1, wherein event completion time ranges are based on a logarithmic scale.

5. The method as in claim 1, further comprising:
generating a response to a query regarding the observability data by specifying a list of clients associated with one or more particular queried events and/or one or more particular queried event completion time ranges.

6. The method as in claim 1, further comprising:
generating a response to a query regarding the observability data by creating a visual representation of clients associated with a particular queried event, wherein the visual representation of each client further represents a respective event completion time range corresponding to that client.

7. The method as in claim 1, wherein the hashed event value includes a two-byte representation of a hash of an event and a corresponding set size value.

8. The method as in claim 1, wherein the plurality of time range indicators representative of respective event completion time ranges comprises one-byte representations.

9. The method as in claim 1, wherein the observability data for the sequenced events is obtained in a non-normalized format.

10. The method as in claim 1, further comprising:
storing the observability data for the sequenced events indexed by their corresponding hashed event values and their corresponding associated time range indicators.

11. The method as in claim 1, wherein each event of the sequenced events is in a representative format selected from a group consisting of: a string; an identifier; a type; an enumeration; a composed textual line; a file; and a log entry.

12. The method as in claim 1, wherein the respective event completion time ranges are manually configured.

13. The method as in claim 1, wherein the respective event completion time ranges are determined based on dividing the observability data into a number of ranges.

14. The method as in claim 1, wherein storing the observability data for the sequenced events further comprises:
appending an owner of an event stream to the observability data being stored.

15. The method as in claim 1, wherein the device is an observability agent sending the observability data for the sequenced events stored as corresponding hashed event values and corresponding associated time range indicators to a central server.

16. The method as in claim 1, wherein the device is a central server, receiving the observability data in a raw format from a plurality of agents.

17. A tangible, non-transitory, computer-readable medium having computer-executable instructions stored thereon that, when executed by a processor on a computer, cause the computer to perform a process comprising:
obtaining observability data for sequenced events in a computing network;
normalizing each event of the sequenced events into a hashed event value;
associating observability data corresponding to each event to a particular time range indicator of a plurality of time range indicators representative of respective event completion time ranges; and
storing the observability data for the sequenced events as corresponding hashed event values and corresponding associated time range indicators.

18. The tangible, non-transitory, computer-readable medium as in claim 17, wherein the process further comprises:
generating a response to a query regarding the observability data including one or more of:
a list of clients associated with one or more particular queried events and/or one or more particular queried event completion time ranges; and
a visual representation of clients associated with a particular queried event, wherein the visual representation of each client further represents a respective event completion time range corresponding to that client.

19. The tangible, non-transitory, computer-readable medium as in claim 17, wherein the process further comprises:
storing the observability data for the sequenced events indexed by their corresponding hashed event values and their corresponding associated time range indicators.

20. An apparatus, comprising:
one or more network interfaces;
a processor coupled to the one or more network interfaces and configured to execute one or more processes; and
a memory configured to store a process that is executable by the processor, the process when executed configured to:
obtain observability data for sequenced events in a computing network;
normalize each event of the sequenced events into a hashed event value;
associate observability data corresponding to each event to a particular time range indicator of a plurality of time range indicators representative of respective event completion time ranges; and
store the observability data for the sequenced events as corresponding hashed event values and corresponding associated time range indicators.
